(19) United States
(12) Patent Application Publication
(10) Pub. No.: US 2026/0277815 A1
(43) Pub. Date: Sep. 17, 2026

(54) ARBITRATED SHARED INSTRUCTION MEMORY

(71) Applicant: Micron Technology, Inc,, Boise, ID (US)

(72) Inventor: Leon Zlotnik, Camino, CA (US)

(21) Appl. No.: 19/559,246

(22) Filed: Mar. 6, 2026

Related U.S. Application Data
(60) Provisional application No. 63/771,372, filed on Mar. 13, 2025.

(51) Int. Cl. G06F 12/0875

(52) U.S. Cl. CPC G06F 12/0875; G06F 2212/452

(57) ABSTRACT

The present disclosure introduces a system for managing access to shared instruction memory in multi-processor environments, utilizing advanced arbitration and flow control strategies. The system may include a controller with a collision manager that dynamically prioritizes access requests based on timing requirements and urgency, reducing latency and optimizing memory access patterns. In some examples, it incorporates mechanisms for handling overlapping, prioritized, protected, exclusive, and atomic addresses, enhancing efficiency and resource utilization. Additionally, a common cache and multi-cache controller may be used to facilitate seamless integration and synchronization between processors and system components, improving performance and power efficiency over traditional methods.

### PRIORITY APPLICATION

This application claims the benefit of priority to U.S. Provisional Application Ser. No. 63/771,372, filed Mar. 13, 2025, which is incorporated herein by reference in its entirety.

### TECHNICAL FIELD

Embodiments pertain to memory management systems in computing architectures. Some embodiments relate to methods and apparatuses for managing access to shared instruction memory in multi-processor environments.

### BACKGROUND

Modern computing systems are designed to handle a wide range of applications, from simple tasks like word processing to complex computations required in scientific simulations and data analysis. At the heart of these systems are processing units, such as central processing units (CPUs) and microcontrollers, which execute instructions to perform various operations.

Many modern computing systems feature multiple processing units that are capable of processing one or more instructions in parallel. These processing units may be separate units (e.g., separate physical dies), chiplets, or may feature multiple cores integrated within a single processor. Multiple processing units allow for parallel execution of instructions, enhancing the system's ability to handle complex workloads and improves performance in multitasking environments. Each processing unit can independently execute instructions, enabling the system to perform multiple operations simultaneously. This parallel processing capability is particularly beneficial in applications that require significant computational power, such as gaming, data processing, and scientific simulations.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of a portion of a computing system for managing memory access according to some examples of the present disclosure.

FIG. 2 illustrates a diagram of instruction accesses of two processing units according to some examples of the present disclosure.

FIG. 3 shows an example of a portion of a computing system with an improved memory arbitration system implemented by a collision manager according to some examples of the present disclosure.

FIG. 4 shows a diagram of instruction accesses of two processing units in a priority-based system according to some examples of the present disclosure.

FIG. 5 illustrates a flowchart of a method for arbitrating access to shared instruction memory using a prioritization policy according to some examples of the present disclosure.

FIG. 6 illustrates a block diagram of an example machine upon which any one or more of the techniques discussed herein may be performed.

### DETAILED DESCRIPTION

Instruction memory refers to memory that stores the instructions that processing units execute to run programs. When a processing unit needs to execute a program, it fetches instructions from this memory through a process called instruction fetching. The efficiency of this fetching process directly impacts system performance, as the speed and timing of instruction retrieval affects how quickly the processing unit can execute operations. Processing units access instruction memory by providing addresses to fetch specific instructions, which are then retrieved and executed. The fetched instructions can include various types of operations such as data transfer instructions (load, store, move, push, pop), arithmetic instructions (add, subtract, multiply, divide), logical instructions (AND, OR, XOR), control flow instructions (jump, conditional jump, call, return), comparison instructions, bit manipulation instructions, input/output instructions, and vector/multimedia instructions.

In some systems, a separate instruction memory is provided for each processing unit of the system. This architecture allows each processing unit to access instructions independently, even when multiple processing units are executing the same code. While this method ensures uninterrupted access, it is highly inefficient in terms of both area and power consumption, leading to a significant waste of resources, especially in systems where numerous processing units are deployed that execute the same instructions. In these examples, the duplication of instruction memories represents a substantial overhead in silicon area and power usage.

To avoid this overhead, in other systems one or more instruction memories may be shared by multiple processing units of the system. While this approach reduces area and power consumption compared to dedicated memories, it introduces issues related to access arbitration. For example, when two processing units are attempting to access the shared instruction memory simultaneously, typical arbitration techniques gate the clock to an entire processing unit to wait for the instruction to be fetched, which can severely compromise performance.

Some systems attempt to solve the flow control issue by introducing a controller with collision management to handle concurrent memory access requests from multiple processing units. In these systems, when collisions occur between multiple processing units attempting to access the memory simultaneously, the memory system returns an alternative instruction, such as a JUMP instruction. Because more complex processing units typically implement sophisticated instruction pipelines where each instruction may span several clock cycles due to multi-stage processing operations, returning the alternative instruction (rather than halting all execution) allows the processor to finish other stages or instructions in the pipeline.

In addition, many processing units also utilize branch prediction and instruction pre-fetching where the processing units attempt to predict and pre-fetch future instructions based upon the present instructions. Sometimes the processor predicts the wrong instructions and the instructions that were pre-fetched are never executed. If the instruction for which the alternative instruction was substituted is not executed (e.g., a branch misprediction case), by utilizing the alternative instruction, the performance of the processor unit is not impacted by waiting for an instruction not actually executed, unlike with traditional methods which pause execution.

Finally, even if the instruction for which the alternative instruction was substituted is eventually executed, these systems may include an instruction cache which fetches and caches the instructions after the alternative instruction is issued. If the processor pipeline is long enough, by the time the processor actually executes the alternative instruction, the actual instruction is already in the instruction cache. The alternative instruction (e.g., the JUMP instruction) causes the processing unit to request the instruction again from memory. Because of the previously issued request which resulted in the fake JUMP instruction, in many cases the instruction is already cached which may allow the instruction to be quickly returned.

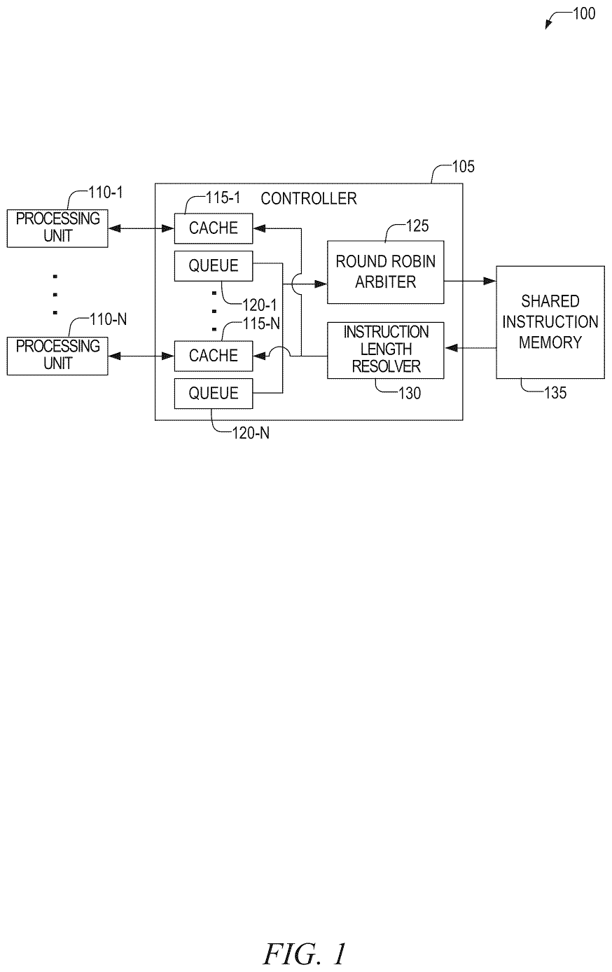

FIG. 1 illustrates an example of a portion of a computing system 100 for managing memory access that issues an alternative instruction according to some examples of the present disclosure. The computing system 100 may be, or be a portion of, a computing device such as a desktop computer, laptop computer, server, network server, mobile computing device, or the like. As illustrated in FIG. 1, the computing system 100 includes processing units 110-1, . . . , 110-N. Processing units, as used herein, comprise logic that executes instructions retrieved from a memory. Example processing units may include one or more cores of a central processor unit (CPU), graphics processing unit (GPU), digital signal processor (DSP), etc. The processing units 110-1, . . . , 110-N may generate and issue (e.g., provide) an access request to access (e.g., to write data to or read data from) locations within a shared instruction memory 135. In some embodiments, the processing units 110 can each be a separate processor, or one or more of the processing units 110 may be multiple cores (e.g., CPUs) within a same processor, such as in a multi-core processor design.

The computing system 100 includes one or more memory devices, and in the example computing system 100, a shared instruction memory 135 is shown. In some examples, the shared instruction memory 135 can be a tightly coupled memory (TCM), which refers to a memory that is located near to the processing units 110 and/or controller 105 and has a constant access time (e.g., deterministic), as compared to cache memory which has a variable access time since there can be a cache “hit” or “miss.” A TCM is often used for time sensitive routines and/or real time tasks for which constant access time may be necessary. In some examples, the shared instruction memory 135 may be a Dynamic Random Access Memory (DRAM) or Static Random Access Memory (SRAM), for example. The shared instruction memory 135 may store instructions that cause the processing units 110 to perform operations.

Accessing shared instruction memory 135 by processing units 110 can include “fetching” instructions from the shared instruction memory 135. For example, processing units 110 may access the shared instruction memory 135 to fetch instructions and execute them once received. Fetching instructions from the shared instruction memory 135 can involve providing addresses (via controller 105) to the shared instruction memory 135 that specifies a location within the shared instruction memory 135 from which the instructions are to be fetched.

The types of instructions that can be fetched from the shared instruction memory 135 include, but are not limited to, data transfer instructions (such as load, store, move, push, and pop), arithmetic instructions (like add, subtract, multiply, divide, increment, and decrement), logical instructions (including AND, OR, XOR, NOT, and shift operations), control flow instructions (such as jump, conditional jump, call, return, and loop), comparison instructions (compare and test), bit manipulation instructions (set/clear bit and rotate), input/output instructions (in and out), special instructions (NOP and halt), floating-point instructions (for arithmetic operations on floating point numbers and load/store operations), vector/multimedia instructions, and the like.

As illustrated in FIG. 1, the computing system 100 includes a controller 105 through which shared instruction memory 135 can be accessed by the processing units 110. The controller 105 can include hardware circuitry to perform the operations described herein. For example, the controller 105 can include special purpose circuitry in the form of an ASIC, FPGA, state machine, and/or other logic circuitry. In other examples, the controller 105 may be a memory controller of a memory system. In some examples, the controller 105 may be part of one or more of the processing units 110.

As illustrated in FIG. 1, the shared instruction memory 135 can be “shared” by multiple processing units 110. In other words, data stored in the same shared instruction memory 135 can be accessed (e.g., retrieved and utilized) by multiple processing units 110. In a particular example, where the shared instruction memory 135 stores instructions, these instructions can be fetched to and executed at the multiple processing units 110.

The controller 105 can include and/or provide caches 115-1, . . . , 115-N (collectively referred to as caches 115) and queues 120-1, . . . , 120-N (collectively referred to as queues 120) for the respective processing units 110-1, . . . , 110-N. The caches 115 may temporarily store data, such as the most recently and/or frequently accessed data retrieved from the shared instruction memory 135 for a corresponding processing units 110. The queues 120 may temporarily store access requests provided by and received from the respective processing units 110. In an example where the shared instruction memory 135 stores instructions that can be fetched by the processing units 110, the caches 115 can store instructions fetched from the shared instruction memory 135, while the queues 120 can store access requests (which may take the form of addresses of the shared instruction memory 135) provided by and received from the processing units 110. For example, if the processing unit 110-1 requests an instruction at a first address of the shared instruction memory 135, the controller 105 first accesses the cache 115-1 to determine if the instruction at the given address is present in the cache. If the instruction is present, the instruction is sent back to the processing unit 110-1. If the instruction is not present, the shared instruction memory 135 is accessed through the round robin arbiter 125.

In some examples, round robin arbiter 125 may arbitrate accesses to the shared instruction memory 135 and organizes data accessed (e.g., retrieved) from the shared instruction memory 135 so that the data can be sent to the caches 115 in the same order they were received at the controller 105. Round robin arbiter 125 may arbitrate conflicting requests to access the shared instruction memory 135 by using a round-robin approach. Additionally, the controller 105 includes an instruction length resolver 130 which can identify the size of the data (e.g., the length of an instruction) retrieved from the shared instruction memory 135.

The components of controller 105, such as the round robin arbiter 125, caches 115, queues 120, and instruction length resolver 130 can each include hardware circuitry to perform the operations described herein. For example, the round robin arbiter 125 and instruction length resolver 130 may each be or include special purpose circuitry in the form of an ASIC, FPGA, state machine, and/or other logic circuitry. The caches 115 and queues 120 may be memory such as registers, static random-access memory (SRAM), embedded Dynamic Random Access Memory, or the like.

The round robin arbiter 125 of controller 105 may manage data retrieval (e.g., fetching instructions) from the shared instruction memory 135 to provide conflict-free access for multiple processing units 110. More specifically, the controller 105 may manage access requests from the processing units 110 in a way that ensures various requirements (e.g., timing requirements) associated with the access requests are still met, even if data retrievals are delayed due to the shared instruction memory 135 being accessed simultaneously by multiple processing units 110.

In some examples the round robin arbiter 125 arbitrates collisions between processing units 110 to access to shared instruction memory 135 by using a round-robin approach. Round-robin arbitration is a scheduling technique used to manage access to a shared resource, such as memory, by multiple processors or devices. It allocates access in a cyclic order, ensuring that each processor or device gets an equal opportunity to access the resource in a fair and predictable manner, thereby preventing any single entity from monopolizing the resource. While round-robin is fair and predictable, as will be demonstrated, it may not be the most efficient when processor characteristics are taken into account.

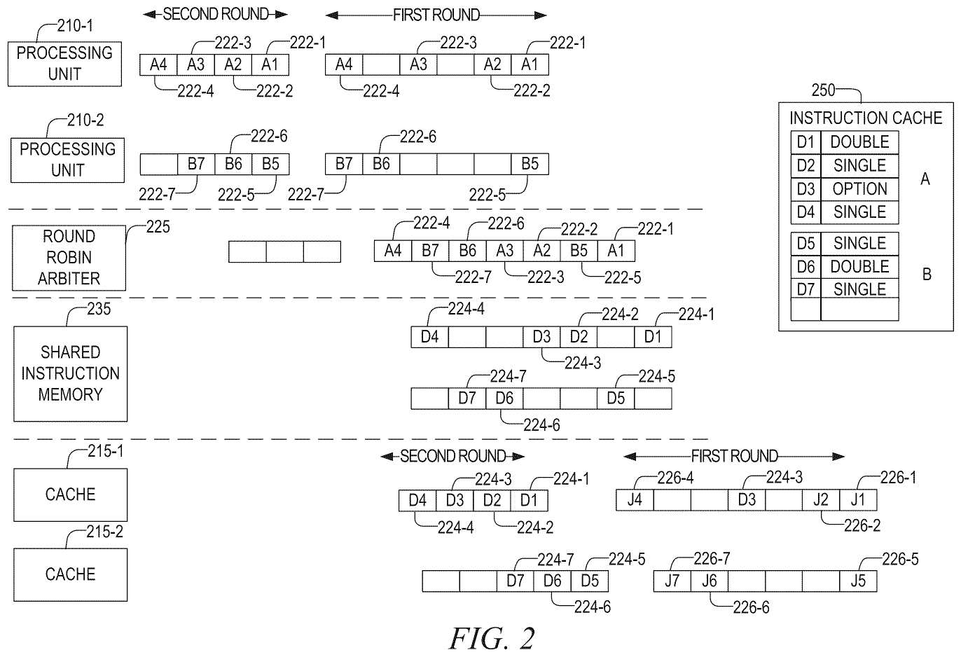

Further details associated with the management of access requests are illustrated in FIG. 2. FIG. 2 illustrates a diagram of instruction accesses of two processing units according to some examples of the present disclosure. FIG. 2 provides a detailed illustration of how access requests 222 from two processing units, 210-1 and 210-2, are managed when accessing a shared instruction memory 235 using a round robin scheme. In FIG. 2, processing unit 210-1 issue access requests 222-1, 222-2, 222-3, and 222-4; and processing unit 210-2 issues access requests 222-5, 222-6 and 222-7. Each access request is associated with an address in shared instruction memory 235 that corresponds to an instruction. In FIG. 2, addresses of the access requests are denoted by either an ‘A’ or ‘B’ followed by a number. ‘A’ indicates an address associated with processing unit 210-1 and ‘B’ indicates an address associated with processing unit 210-2. The number is used to differentiate accesses, such that A1 is a different access request than A4, even though the actual address may be a same or different address. These access requests are processed by the round robin arbiter 225 to load corresponding instructions D1 224-1, D2 224-2, D3 224-3, D4 224-4, D5 224-5, D6 224-6, and D7 224-7 from the shared instruction memory 235 into caches 215-1 and 215-2. Note that instruction D1 224-1 corresponds to the instruction at the address given by access request A1 222-1, D2 224-2 corresponds to the instruction at the address given by access request A2 222-2, and so on. Cache 215-1 corresponds to processing unit 210-1 and cache 215-2 corresponds to processing unit 210-2.

The access requests 222 are processed by the round robin arbiter 225, which employs a round-robin approach to manage conflicts and prioritize access. This ensures that addresses are provided to the shared memory in a specific order based on their arrival and priority. In the case of FIG. 2, the order addresses are issued from the processing unit proceeds from right to left. Thus access requests A1 222-1 and B5 222-5 are issued first, then A2 222-2 and so on. The instruction lengths of the instructions corresponding to the various access requests are shown in the box 250.

In a specific example, processing unit 210-1 issues consecutive access requests A1 222-1 and A2 222-2 as these each request one half of a double instruction. Simultaneously with the access request A1 222-1, processing unit 210-2 issues an access request B5 222-5. In FIG. 2, the round robin arbiter 225, employing a round-robin approach, prioritizes the access request A1 222-1 first, then the request for B5 222-5, and then A2 222-2.

Even though the access request A1 222-1 was prioritized by the round robin arbiter 225 using the round-robin arbitration, and the instruction D1 224-1 is made available, because D1 is a double length instruction, the second portion of the instruction, D2 224-2, is not immediately available due to the round robin arbiter 225 fetching the instruction D5 224-5 corresponding to access request B5 222-5 first. Thus, the timing requirements for delivering the instruction to the processing unit 210-1 may not be met.

In this instance, and as shown in FIG. 2, the timing requirements are not met and the system issues alternative instructions, such as JUMP instructions 226-1 and 226-2, to processing unit 210-1 to maintain the flow of operations on the processing unit 210-1. These instructions effectively act as a placeholder, allowing the processing unit 210-1 to continue executing other tasks while waiting for the complete instruction. Consequently, these JUMP instructions trigger a “second round” of requests from the processing units, where processing unit 210-1 reissues the request for “A1” and “A2” to obtain the remaining portion of the double-length instruction.

Similarly, because fetching instruction D5 224-5 due to request B5 222-5 was delayed by fetching D1 224-1 due to request A1 222-1, the timing requirements of access request B5 222-5 were not met and an alternative instruction J5 226-5 is issued and processing unit 210-2 may reissue its request for “B5” to access its desired instruction in a second round. Likewise, alternative instructions 226-4, 226-6, 226-7 are also issued due to the systems inability to meet the timing requirements of the processing units 210-1 and 210-2.

Also in FIG. 2, processing unit 210-1 requested A3 222-3 in the 1st round and received the data D3 224-3 for it. Then, in the second round the processing unit 210-1 may (not necessarily will) request the same A3 as it was given a JUMP only instead of D1, D2 and D4, hence, this instruction is optional. The system doesn't have to send a request out to fetch A3 from the memory. If the processing unit 210-1 asks for it, it will be sent again from the cache.

As FIG. 2 demonstrates, the system's reliance on a round-robin allocation approach may cause a second round of access requests for both processing units 210-1 and 210-2 to resolve conflicts which can lead to performance inefficiencies. The need for multiple rounds can exacerbate latency issues, particularly in systems with high contention for memory access. Further, in systems with varying instruction lengths and timing requirements, round-robin scheduling can result in suboptimal memory access patterns. Processing units with more urgent or time-sensitive requests may be forced to wait, leading to increased latency and reduced system performance. This approach does not account for the priority or urgency of requests, which may be important in high-performance computing environments.

Disclosed in some examples are methods, systems, devices, and machine-readable mediums which address the inefficiencies of managing access requests in shared instruction memory systems by implementing advanced arbitration and flow control strategies. These strategies prioritize access requests based on one or more policies rather than relying solely on round-robin scheduling to optimize memory access patterns and reduce latency.

In some examples, a controller equipped with a collision manager employing intelligent arbitration mechanisms is introduced that resolves conflicts for shared instruction memory amongst a plurality of access requests from multiple processing units using one or more policies. This controller can incorporate various policies, such as fixed priority, cyclic, polling, and dynamic priority, to ensure that time-sensitive requests are handled promptly. By providing differing arbitration strategies the need to issue alternative instructions may be reduced, which reduces a necessity for multiple instruction fetch rounds.

The disclosed advanced arbitration mechanisms incorporate one or more policies to manage access requests effectively. Example, policies may include, fixed priority, cyclic priority, and dynamic priority. Fixed priority assigns a predetermined priority level to each processing unit, ensuring that requests from higher-priority units are always addressed before those from lower-priority units. This approach may be especially beneficial in scenarios where certain tasks are consistently more critical than others, allowing for predictable and efficient handling of time-sensitive operations.

Cyclic priority, rotates which processing unit has priority among processing units in a cyclic manner, ensuring that each unit gets an equal opportunity to have priority access to the shared memory over time. This method balances fairness and efficiency, preventing any single unit from monopolizing the memory resource while still allowing for periodic prioritization of different units.

Dynamic priority combines elements of the other policies, adjusting the priority of access requests based on a variety of factors, such as the urgency of the task, the current system load, and historical access patterns. This flexible approach enables the system to optimize memory access dynamically, adapting to changing conditions and ensuring that resources are allocated efficiently to meet the needs of all processing units.

Instead of, or in addition to, arbitrating based upon which processing unit issued a request and when, the collision manager may arbitrate based upon the requested address. That is, in addition to, or instead of the aforementioned priority mechanisms, the collision manager can identify specific addresses or blocks of addresses that require higher priority access. When these prioritized addresses are detected, the collision manager elevates their access priority, even if other priority mechanisms do not suggest it. This capability is particularly beneficial for accessing time-sensitive parts of the code, as it can significantly reduce latency and ensure that critical instructions are fetched and executed promptly.

The present disclosure also introduces additional improvements that may be used to further optimize memory access and enhance system performance. One such mechanism is the handling of overlapping addresses. In traditional systems, multiple requests for the same memory address can lead to redundant reads, wasting resources and increasing latency. The collision manager in this invention can detect such overlapping address requests and resolve them by eliminating duplicates. This ensures that the memory is read only once for each unique address, thereby reducing unnecessary memory accesses and improving overall efficiency. In some examples, the collision manager may not only detect reads for a same memory address but may prioritize this request over other requests that do not overlap—ensuring that the multiple processing units that requested this address do not have to wait.

The collision manager may also provide for protected addresses, which prevent access to certain memory locations until a protection mechanism is lifted. This may be especially useful in managing code overlays, where the code in memory is dynamically changed using specific algorithms. By restricting access to these protected addresses, the system can ensure that only valid and updated code is executed, maintaining system integrity and preventing errors.

In addition, the collision manager may provide exclusive addresses, where only one processing unit is allowed to access specific memory addresses. This is particularly useful for an overlay master processor or in scenarios involving dynamic code execution. By granting exclusive access, the system can prevent conflicts and ensure that critical operations are performed without interference from other processing units.

Additionally, the collision manager may support atomic addresses, where an entire block of addresses must be accessed as a whole. This ensures that operations involving these addresses are completed in a single, uninterrupted sequence, maintaining data consistency and preventing partial updates that could lead to errors.

The presently disclosed memory system may instead, or in addition, include a common cache and a multi-cache controller to enhance memory access efficiency. The common cache can store data read from overlapping or duplicating addresses by several processors, either feeding it into all associated caches or retaining it within the common cache. This reduces the occupation of individual instruction caches and conserves power. The common cache can also hold portions, or all of, code currently being overlayed, allowing for earlier code replacement in memory while keeping critical older code accessible, thus reducing or eliminating overlay-induced latency.

The common cache can serve as a hyper tightly coupled memory (TCM) providing simultaneous fast access to time-sensitive code to provide very low latency access. The multi-cache controller facilitates non-interrupted (atomic) instruction sequences toward processors, which facilitates running time-sensitive routines without stalls. It can manage master-trigger sequences, providing fake responses to processors until the trigger sequence is returned.

In some examples, the multi-cache controller may support non-processor agents like DMA, power control, and configuration using external I/O. This enables tight integration between processors and other system components. This I/O can synchronize events, allowing processors to execute code when triggered, without the delays associated with polling or interrupts. The multi-cache controller's flexible protocols allow precise timing and predictable code execution order between processors and associated system components, optimizing performance and resource utilization.

For example, consider a scenario where an Intellectual Property (IP) block is performing processing tasks such as encryption or a Fourier Transform. A Direct Memory Access (DMA) controller loads a block of data into this IP block and signals the processor. The processor must then wait until the data processing is complete. Traditionally, this is achieved either by polling a status or waiting for an interrupt from the IP block.

While both methods have their advantages and disadvantages, the presently disclosed architecture allows for a third approach. Imagine the IP block signaling the multi-cache controller to delay the execution of all code associated with specific addresses until the IP processing is complete.

In this scenario, in the prior art methods, if the IP block finishes processing while the CPU is engaged in other tasks, the interrupt scheme would typically issue an interrupt, which, if not masked, disrupts the current execution. If the interrupt is masked, the CPU must still expend time and power handling the interrupt once it is ready. Polling is even less efficient; although the CPU does not waste time until it is ready to process the IP data, once it is ready, the overhead is significant due to repeated reading, comparing, and looping.

By allowing the multi-cache controller to block execution from specific addresses, improvements can be made upon both previous mechanisms:

If the CPU is ready but the IP block is not, the CPU does not need to engage in polling. These loops will occur naturally due to the JUMP instruction. If both the CPU and IP block are ready, there is no interrupt handler to add latency and reduce performance. If the CPU is not ready but the IP block is, there is no interrupt to mask. Overall, this approach is akin to triggered or protected code execution. The multi-cache controller can block certain code from being executed by a specific CPU until a trigger or event occurs.

The disclosed memory system reduces area and power consumption by removing the necessity for duplicate tightly coupled memory (TCM) instances, thereby optimizing the silicon footprint and energy efficiency. The memory system also enhances wake and boot power efficiency and reduces latency by decreasing the total amount of firmware required to be loaded, resulting in quicker system startup times. Furthermore, it offers improved performance and power efficiency compared to existing shared TCM solutions by supporting complex firmware protocols, including code overlay, atomic, protected, triggered, and timed accesses. Additionally, the invention provides more efficient alternatives to traditional polling and interrupt mechanisms, leading to a more streamlined and responsive system operation.

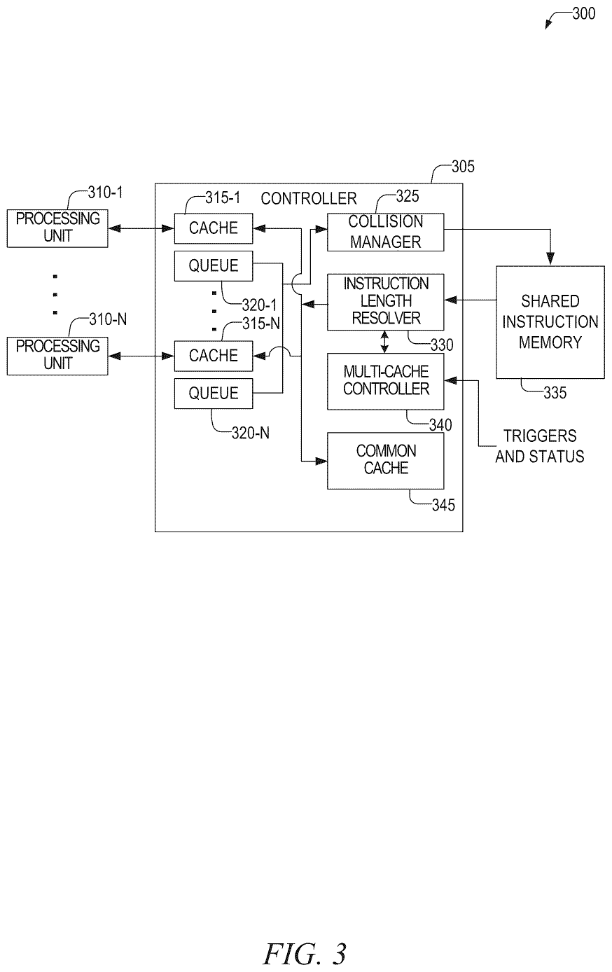

FIG. 3 shows an example of a portion of a computing system 300 with an improved memory arbitration system implemented by a collision manager according to some examples of the present disclosure. The computing system 300 may be, or be a portion of, a computing device such as a desktop computer, laptop computer, server, network server, mobile computing device, or the like. As illustrated in FIG. 3, the computing system 300 includes multiple processing units 310-1 through 310-N, each of which is connected to a controller 305. Processing units, as used herein, comprise logic that executes instructions retrieved from a memory. Example processing units may include one or more cores of a central processor unit (CPU), graphics processing unit (GPU), digital signal processor (DSP), etc. The processing units 310-1, . . . , 310-N may generate and issue (e.g., provide) an access request to access (e.g., to write data to or read data from) locations within a shared instruction memory 335—such as to retrieve instructions. In some embodiments, the processing units 310 can each be a separate processor, or one or more of the processing units 310 may be multiple cores (e.g., CPUs) within a same processor, such as in a multi-core processor design.

The computing system 300 includes one or more memory devices, and in the example computing system 300, a shared instruction memory 335 is shown. In some examples, the shared instruction memory 335 can be a tightly coupled memory (TCM), which refers to a memory that is located near to the processing units 310 and/or controller 305 and has a constant access time (e.g., deterministic), as compared to cache memory which has a variable access time since there can be a cache “hit” or “miss.” A TCM is often used for critical routines and/or real time tasks for which constant access time may be necessary. In some examples, the shared instruction memory 335 may be a Dynamic Random Access Memory (DRAM) or Static Random Access Memory (SRAM), for example. The shared instruction memory 335 may store instructions that cause the processing units 310 to perform operations.

Accessing shared instruction memory 335 by processing units 310 can include “fetching” instructions from the shared instruction memory 335. For example, processing units 310 may access the shared instruction memory 335 to fetch instructions and execute them once received. Fetching instructions from the shared instruction memory 335 can involve providing addresses (via controller 305) to the shared instruction memory 335 that specifies a location within the shared instruction memory 335 from which the instructions are to be fetched.

The types of instructions that can be fetched from the shared instruction memory 335 include, but are not limited to, data transfer instructions (such as load, store, move, push, and pop), arithmetic instructions (like add, subtract, multiply, divide, increment, and decrement), logical instructions (including AND, OR, XOR, NOT, and shift operations), control flow instructions (such as jump, conditional jump, call, return, and loop), comparison instructions (compare and test), bit manipulation instructions (set/clear bit and rotate), input/output instructions (in and out), special instructions (NOP and halt), floating-point instructions (for arithmetic operations on floating point numbers and load/store operations), vector/multimedia instructions, and the like.

The controller 305 is responsible for managing access to a shared instruction memory 335, ensuring that multiple processing units can efficiently retrieve instructions without conflicts or delays. The controller 305 can include hardware circuitry to perform the operations described herein. For example, the controller 305 can include special purpose circuitry in the form of an ASIC, FPGA, state machine, and/or other logic circuitry. In other examples, the controller 305 may be a memory controller of a memory system. In some examples, the controller 305 may be part of one or more of the processing units 310.

As illustrated in FIG. 3, the shared instruction memory 335 can be “shared” by multiple processing units 310. In other words, data stored in the same shared instruction memory 335 can be accessed (e.g., retrieved and utilized) by multiple processing units 310. In a particular example, where the shared instruction memory 335 stores instructions, these instructions can be fetched to and executed at the multiple processing units 310.

Each processing unit 310 is associated with a cache 315 and a queue 320. The caches 315-1 through 315-N temporarily store instructions fetched from the shared instruction memory 335, allowing for quick access and reducing the need for repeated memory accesses. The queues 320-1 through 320-N store access requests from the processing units, which are then managed by the controller 305.

The controller 305 includes a collision manager 325 that handles concurrent access requests from multiple processing units, ensuring that conflicts are resolved and that instructions are provided in the correct order. In some examples, the collision manager 325 resolves conflicts using one or more policies. Policies may be set by an administrator, or by the system. Instead of a round-robin policy, such as shown in FIG. 1, the collision manager 325 may utilize other policies, such as giving priority to certain processing units 310 over others, giving priority to requests for instructions from certain locations of the shared instruction memory 335, giving priority to requests for certain types of instructions, and the like.

An instruction length resolver 330 identifies the size of the instructions retrieved from the shared instruction memory 335, allowing the system to accommodate varying instruction lengths efficiently. Table 250 illustrates different instruction lengths. The function of the instruction length resolver is to determine whether an instruction is complete (such as a single instruction) or a part of a larger instruction (such as a double instruction). In Table 250, instructions D1 and D2 together form a complete instruction that consists of two parts. Therefore, D1 is marked as a double (part) and D2 as a single (full) instruction. In general, there may be longer instructions that consist of more than two parts. For instance, if an instruction requires four cycles (parts), the first, second, and third parts can be marked as double (part), and only the fourth part is marked as single (full). A partial instruction cannot be released to the processor, as the rest cannot be replaced by an alternative instruction. Thus, the first instruction in a multi-part instruction is replaced with an alternative instruction until all parts are ready.

A multi-cache controller 340 is also part of the controller 305, managing the distribution of instructions to the caches 315 and coordinating with a common cache 345. The common cache 345 can store data read from overlapping or duplicating addresses, reducing the occupation of individual instruction caches and conserving power. This setup allows for more efficient memory access, particularly in systems with complex instruction patterns or high contention for memory resources.

The shared instruction memory 335 is accessed by the controller 305, which manages the flow of instructions to the processing units 310. The multi-cache controller utilizes triggers and status signals, which provide additional control and synchronization capabilities, ensuring that the processing units can execute instructions in a timely and coordinated manner. This architecture supports advanced arbitration and flow control strategies, optimizing memory access patterns and reducing latency in multi-processor environments. There are various ways in which triggers and status signals can be utilized by the multi-cache controller. One example, as previously mentioned, involves using these signals to manage the execution order between CPUs or between a CPU and a Direct Memory Access (DMA) controller. These triggers and statuses can be linked to external registers accessible by the CPU or DMA for writing or setting. For instance, consider a register that the DMA can set upon completing a data transfer. This setup allows the system to block specific CPUs from executing code that reads this data until the DMA task is finished. Once the DMA completes its job, the blockage is automatically lifted. This approach is similar to protected or atomic operations. In some examples, this blocking may be handled by the collision manager. This may be less efficient because, once the block is lifted, a request would need to be sent out, subjecting it to arbitration. By blocking and releasing already cached code latency and uncertainty due to the arbitration algorithm is avoided.

The components of controller 305, such as the collision manager 325, caches 315, queues 320, and instruction length resolver 330 can each include hardware circuitry to perform the operations described herein. For example, the collision manager 325 and instruction length resolver 330 may each be or include special purpose circuitry in the form of an ASIC, FPGA, state machine, and/or other logic circuitry. The caches 315 and queues 320 may be memory such as registers, static random access memory (SRAM), embedded Dynamic Random Access Memory, or the like.

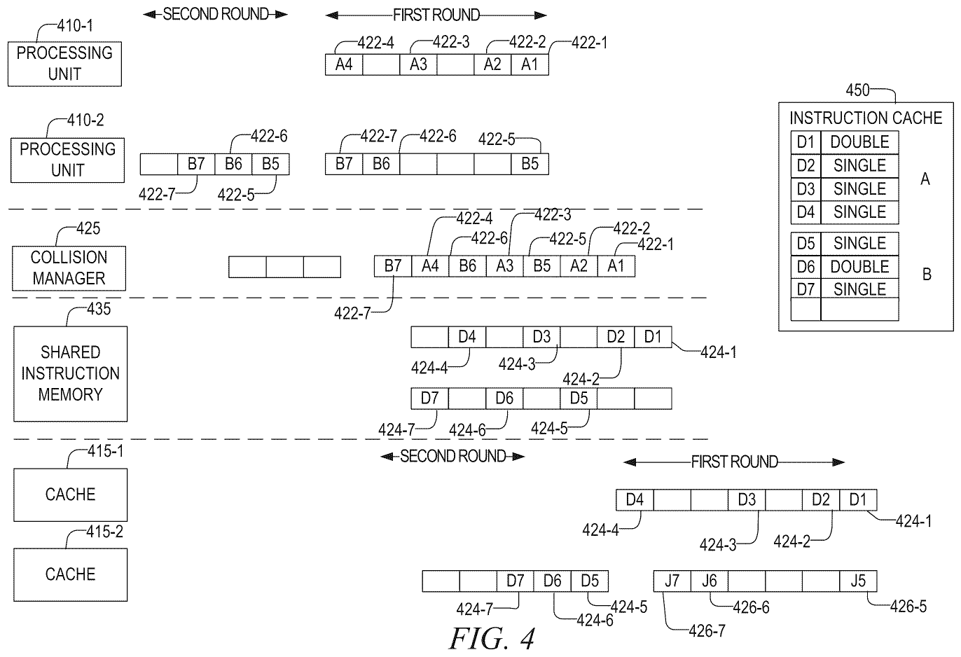

FIG. 4 shows a diagram of instruction accesses of two processing units 410-1 and 410-2 in a priority-based system according to some examples of the present disclosure. This figure illustrates the interaction between the processing units 410-1 and 410-2, a collision manager 425, a shared instruction memory 435, and caches 415-1 and 415-2, highlighting the priority-based arbitration mechanism employed to manage instruction access. This figure differs from FIG. 2 in that instead of a round robin arbitration, the collision manager 425 prioritizes access requests from processing unit 410-1.

The processing units 410-1 and 410-2 issue access requests for instructions at specific addresses of shared instruction memory 435, denoted as A1, A2, A3, A4 for processing unit 410-1, and B5, B6, B7 for processing unit 410-2. These access requests are managed by the collision manager 425, which prioritizes the access requests based on a policy. In this example, processing unit 410-1 is prioritized over processing unit 410-2. The system operates in two rounds: a first round and a second round. During the first round, the collision manager 425 processes the requests in a specific order, prioritizing requests of processing unit 410-1 over those of processing unit 410-2.

The shared instruction memory 435 stores the instructions corresponding to the requested addresses from the access requests. The instructions are labeled as D1, D2, D3, D4, D5, D6, and D7. These instructions are all the same size (e.g., the shared memory data width) but they may represent a full or partial instruction as noted by the box 450. The collision manager 425 ensures that the instructions are fetched from the shared instruction memory 435 and delivered to the appropriate caches 415-1 and 415-2 in the correct order determined by the policy scheme used.

In the first round, the collision manager 425 processes the access requests A1, A2, A3, A4, B5, B6, and B7, fetching the corresponding instructions D1, D2, D3, D4, D5, D6, and D7. The instructions are then stored in the caches 415-1 and 415-2, allowing the processing units 410-1 and 410-2 to access them efficiently. The system employs a priority-based arbitration mechanism, which can eliminate the need for a second round of requests for certain processing units, as demonstrated by the absence of a second round for processing unit 410-1. In particular, the access requests A1 and B5 are received by the collision manager at a same time unit. Based upon processing unit 410-1 having priority, the access request A1 422-1 is selected. Since the processing unit 410-1 has priority, the collision manager will process everything processing unit 410-1 requests prior to requests from processing unit 410-2, thus the instructions for both access request A1 422-1 and request A2 422-2 are fetched. The instruction for access request B5 422-5 is then fetched next, followed by the instructions for access request A3 422-3 and access request B6 422-6. Next, both access request B7 422-7 and access request A4 422-4 are requested simultaneously. Because of the priority of the processing unit 410-1, the access request A4 is processed before the access request B7 422-7.

As a result, instructions D1 424-1 and D2 424-2 are fetched from shared instruction memory 435 first followed by instructions D5 424-5, then D3 424-3, then D6 424-6, then D4 424-4, and finally D7 424-7. The instructions D1 424-1 and D2 424-2 are placed in cache 415-1—ready for processing unit 410-1. The instruction D5 424-5 however is not read in time and thus, instead of an instruction, a substitute instruction, such as a jump instruction J5 426-5 is placed in the cache 415-2. This instruction tells the processing unit 410-2 to re-request the instruction D5 424-5. Subsequently, the instruction D5 424-5 is read from the shared instruction memory 435 and placed in the cache 415-2 and is available for reading in the second round. Likewise, instruction D3 424-3 and D4 424-4 are read and placed in the cache 415-1. Instructions D6 and D7 arrive too late for processing unit 410-2 and so alternative instructions, such as jump instructions J6 426-6 and 426-7 are placed in cache 415-2. As with instruction D5 424-5, the instructions D6 424-6 and D7 424-7 are ready in the cache 415-2 for the next round. In FIG. 2, D3 was an optional instruction, but in FIG. 4, because the processing unit 210-1 had priority and received everything in the first round, D3 was just a valid single instruction.

In FIG. 2, the round-robin approach required that both processing unit 410-1 and processing unit 410-2 utilize a second round of requests. However, in the prioritization scheme shown in FIG. 4, only processing unit 410-2 requires a second round.

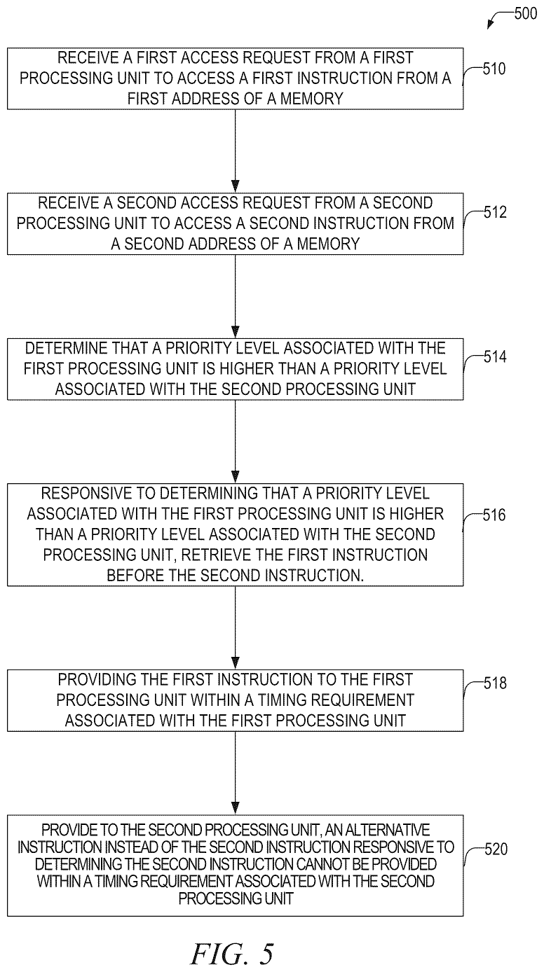

FIG. 5 illustrates a flowchart of a method 500 for arbitrating access to shared instruction memory using a prioritization policy according to some examples of the present disclosure. At operation 510, the method begins by receiving a first access request from a first processing unit to access a first instruction from a first address of a memory. At operation 512, a second access request is received from a second processing unit to access a second instruction from a second address of the memory. This operation highlights the concurrent nature of access requests in a multi-processing environment, where multiple processing units, such as 110-N, may simultaneously request access to shared memory resources, managed by the controller 105.

Operation 514 involves determining that a priority level associated with the first processing unit is higher than a priority level associated with the second processing unit.

In operation 516, responsive to determining that the priority level associated with the first processing unit is higher, the method retrieves the first instruction before the second instruction. This operation ensures that the higher-priority request is fulfilled first, optimizing the access sequence to meet the needs of the prioritized processing unit. The instruction length resolver 130 may be involved in determining the size of the instruction to be retrieved, ensuring efficient memory access.

Operation 518 involves providing the first instruction to the first processing unit within a timing requirement associated with the first processing unit. This operation emphasizes the importance of meeting specific timing constraints to maintain efficient processing and system performance. The cache 115-1 temporarily stores the instruction, allowing the processing unit 110-1 to access it promptly.

Finally, at operation 520, the method provides an alternate instruction to the second processing unit instead of the second instruction, responsive to determining that the second instruction cannot be provided within a timing requirement associated with the second processing unit. This operation ensures that the second processing unit continues to operate smoothly, even if the original request cannot be fulfilled immediately, by providing a substitute instruction, such as a JUMP instruction, to maintain the flow of operations. The cache 115-N and queue 120-N associated with the second processing unit 110-N facilitate this process, ensuring that the alternate instruction is delivered efficiently.

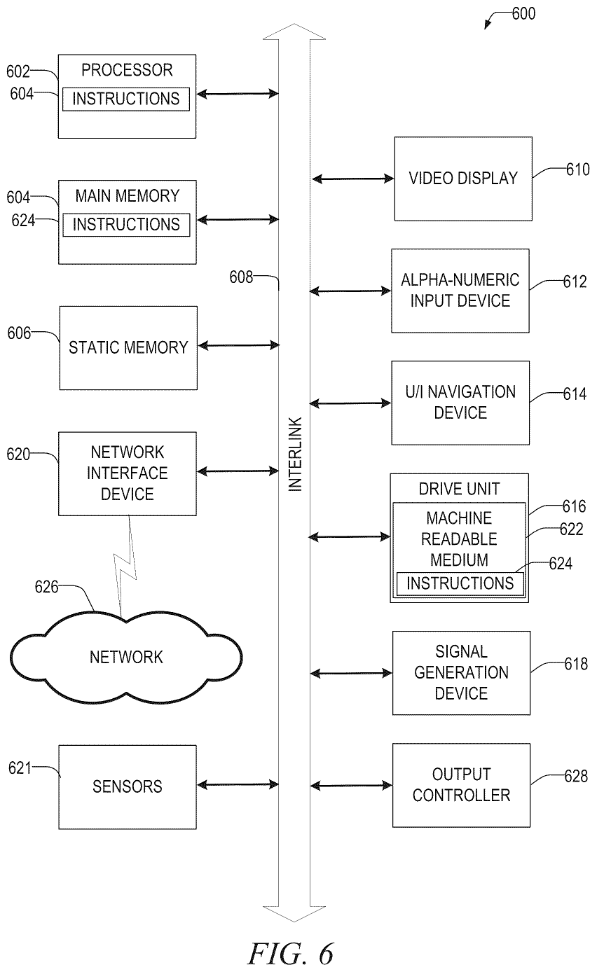

FIG. 6 illustrates a block diagram of an example machine 600 upon which any one or more of the techniques (e.g., methodologies) discussed herein may be performed. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be in the form of a desktop, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 600 may be or include computing system 100, 300; may implement the method 500; and may implement the memory access techniques of FIGS. 2 and 4.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 600 may include one or more hardware processors, such as processor 602. Processor 602 may be a central processing unit (CPU), a graphics processing unit (GPU), a hardware processor core, or any combination thereof. Machine 600 may include a main memory 604 and a static memory 606, some or all of which may communicate with each other via an interlink (e.g., bus) 608. Examples of main memory 604 may include Synchronous Dynamic Random-Access Memory (SDRAM), such as Double Data Rate memory, such as DDR4 or DDR5. Interlink 608 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 624 may further be transmitted or received over a communications network 626 using a transmission medium via the network interface device 620. The Machine 600 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques.

### Other Notes and Examples

Example 1 is a method, comprising: at a memory system, using a hardware processor: receiving, from a first processing unit, a first access request to access a first instruction from a first address of a memory; receiving, from a second processing unit, a second access request to access a second instruction from a second address of the memory; determining a priority level associated with the first processing unit is higher than a priority level associated with the second processing unit; responsive to determining the priority level associated with the first processing unit is higher, retrieving the first instruction from the first address of the memory before retrieving the second instruction from the second address of the memory; providing the first instruction to the first processing unit within a timing requirement associated with the first processing unit; and providing, to the second processing unit, an alternative instruction instead of the second instruction responsive to determining the second instruction cannot be provided within a timing requirement associated with the second processing unit, wherein the alternative instruction, when executed by the second processing unit, causes the second processing unit to subsequently request the second instruction from the second address of the memory.
In Example 2, the subject matter of Example 1 includes, wherein determining the priority level associated with the first processing unit is higher than the priority level associated with the second processing unit comprises determining that a fixed priority level assigned to the first processing unit is higher than a fixed priority level assigned to the second processing unit.
In Example 3, the subject matter of Examples 1-2 includes, wherein determining the priority level associated with the first processing unit is higher than the priority level associated with the second processing unit comprises determining that a type of instruction being accessed by the first processing unit is assigned a higher priority level than a type of instruction being accessed by the second processing unit.
In Example 4, the subject matter of Examples 1-3 includes, updating a fixed priority value assigned to the first and second processing units periodically, wherein during a first time period the priority level assigned to the first processing unit is greater than the priority level assigned to the second processing unit and wherein during a second time period, the priority level assigned to the first processing unit is less than the priority level assigned to the second processing unit; and wherein determining the priority level associated with the first processing unit is higher than the priority level associated with the second processing unit comprises determining that the priority level assigned to the first processing unit during the time period when the first and second access requests were received is higher than the priority level assigned to the second processing unit.
In Example 5, the subject matter of Examples 1-4 includes, storing the first instruction in a common cache accessible by both the first and second processing units.
In Example 6, the subject matter of Example 5 includes, receiving, from the first processing unit, a third access request to access a third instruction from a third address of the memory; receiving, from the second processing unit, a fourth access request to access the second instruction from the second address of the memory; determining the second instruction was previously stored in a common cache in response to the second access request; determining the priority level associated with the first processing unit is higher than the priority level associated with the second processing unit; retrieving the third instruction from the third address of the memory before providing the second instruction from the common cache; and providing the second instruction from the common cache to the second processing unit instead of retrieving the second instruction from the memory.
In Example 7, the subject matter of Examples 1-6 includes, determining the first address and the second address are overlapping addresses in the memory; and retrieving the first instruction only once for both the first and second access requests.
In Example 8, the subject matter of Examples 1-7 includes, receiving, from the first processing unit, a third access request to access a third instruction from a third address of the memory; determining that the third instruction requests access to a protected region of the memory; and in response, denying access to the protected region of the memory until a protection condition elapses by returning an alternative instruction.
In Example 9, the subject matter of Example 8 includes, wherein the protection condition comprises completion of a code overlay operation that updates instructions stored in the protected region.
In Example 10, the subject matter of Examples 1-9 includes, designating a block of addresses in the memory as an atomic block; and requiring all instructions in the atomic block to be retrieved before providing any instructions from the atomic block to either the first or second processing unit.
In Example 11, the subject matter of Examples 1-10 includes, wherein the alternative instruction is a jump instruction.
Example 12 is a non-transitory machine-readable medium, storing instructions for managing access to shared instruction memory, the instructions, which when executed, cause the machine to perform operations comprising: receiving, from a first processing unit, a first access request to access a first instruction from a first address of a memory; receiving, from a second processing unit, a second access request to access a second instruction from a second address of the memory; determining a priority level associated with the first processing unit is higher than a priority level associated with the second processing unit; responsive to determining the priority level associated with the first processing unit is higher, retrieving the first instruction from the first address of the memory before retrieving the second instruction from the second address of the memory; providing the first instruction to the first processing unit within a timing requirement associated with the first processing unit; and providing, to the second processing unit, an alternative instruction instead of the second instruction responsive to determining the second instruction cannot be provided within a timing requirement associated with the second processing unit, wherein the alternative instruction, when executed by the second processing unit, causes the second processing unit to subsequently request the second instruction from the second address of the memory.
In Example 13, the subject matter of Example 12 includes, wherein the operation of determining the priority level associated with the first processing unit is higher than the priority level associated with the second processing unit comprises determining that a fixed priority level assigned to the first processing unit is higher than a fixed priority level assigned to the second processing unit.
In Example 14, the subject matter of Examples 12-13 includes, wherein the operation of determining the priority level associated with the first processing unit is higher than the priority level associated with the second processing unit comprises determining that a type of instruction being accessed by the first processing unit is assigned a higher priority level than a type of instruction being accessed by the second processing unit.
In Example 15, the subject matter of Examples 12-14 includes, wherein the operations further comprise: updating a fixed priority value assigned to the first and second processing units periodically, wherein during a first time period the priority level assigned to the first processing unit is greater than the priority level assigned to the second processing unit and wherein during a second time period, the priority level assigned to the first processing unit is less than the priority level assigned to the second processing unit; and wherein the operation of determining the priority level associated with the first processing unit is higher than the priority level associated with the second processing unit comprises determining that the priority level assigned to the first processing unit during the time period when the first and second access requests were received is higher than the priority level assigned to the second processing unit.
In Example 16, the subject matter of Examples 12-15 includes, wherein the operations further comprise: storing the first instruction in a common cache accessible by both the first and second processing units.
In Example 17, the subject matter of Example 16 includes, wherein the operations further comprise: receiving, from the first processing unit, a third access request to access a third instruction from a third address of the memory; receiving, from the second processing unit, a fourth access request to access the second instruction from the second address of the memory; determining the second instruction was previously stored in a common cache in response to the second access request; determining the priority level associated with the first processing unit is higher than the priority level associated with the second processing unit; retrieving the third instruction from the third address of the memory before providing the second instruction from the common cache; and providing the second instruction from the common cache to the second processing unit instead of retrieving the second instruction from the memory.
In Example 18, the subject matter of Examples 12-17 includes, wherein the operations further comprise: determining the first address and the second address are overlapping addresses in the memory; and retrieving the first instruction only once for both the first and second access requests.
In Example 19, the subject matter of Examples 12-18 includes, wherein the operations further comprise: receiving, from the first processing unit, a third access request to access a third instruction from a third address of the memory; determining that the third instruction requests access to a protected region of the memory; and in response, denying access to the protected region of the memory until a protection condition elapses by returning an alternative instruction.
In Example 20, the subject matter of Example 19 includes, wherein the protection condition comprises completion of a code overlay operation that updates instructions stored in the protected region.
In Example 21, the subject matter of Examples 12-20 includes, wherein the operations further comprise: designating a block of addresses in the memory as an atomic block; and requiring all instructions in the atomic block to be retrieved before providing any instructions from the atomic block to either the first or second processing unit.
In Example 22, the subject matter of Examples 12-21 includes, wherein the alternative instruction is a jump instruction.
Example 23 is a computing device for managing access to shared instruction memory, the computing device comprising: a hardware processor; a memory, the memory storing instructions, which when executed by the hardware processor cause the computing device to perform operations comprising: receiving, from a first processing unit, a first access request to access a first instruction from a first address of a memory; receiving, from a second processing unit, a second access request to access a second instruction from a second address of the memory; determining a priority level associated with the first processing unit is higher than a priority level associated with the second processing unit; responsive to determining the priority level associated with the first processing unit is higher, retrieving the first instruction from the first address of the memory before retrieving the second instruction from the second address of the memory; providing the first instruction to the first processing unit within a timing requirement associated with the first processing unit; and providing, to the second processing unit, an alternative instruction instead of the second instruction responsive to determining the second instruction cannot be provided within a timing requirement associated with the second processing unit, wherein the alternative instruction, when executed by the second processing unit, causes the second processing unit to subsequently request the second instruction from the second address of the memory.
In Example 24, the subject matter of Example 23 includes, wherein the operation of determining the priority level associated with the first processing unit is higher than the priority level associated with the second processing unit comprises determining that a fixed priority level assigned to the first processing unit is higher than a fixed priority level assigned to the second processing unit.
In Example 25, the subject matter of Examples 23-24 includes, wherein the operation of determining the priority level associated with the first processing unit is higher than the priority level associated with the second processing unit comprises determining that a type of instruction being accessed by the first processing unit is assigned a higher priority level than a type of instruction being accessed by the second processing unit.
In Example 26, the subject matter of Examples 23-25 includes, wherein the operations further comprise: updating a fixed priority value assigned to the first and second processing units periodically, wherein during a first time period the priority level assigned to the first processing unit is greater than the priority level assigned to the second processing unit and wherein during a second time period, the priority level assigned to the first processing unit is less than the priority level assigned to the second processing unit; and wherein the operation of determining the priority level associated with the first processing unit is higher than the priority level associated with the second processing unit comprises determining that the priority level assigned to the first processing unit during the time period when the first and second access requests were received is higher than the priority level assigned to the second processing unit.
In Example 27, the subject matter of Examples 23-26 includes, wherein the operations further comprise: storing the first instruction in a common cache accessible by both the first and second processing units.
In Example 28, the subject matter of Example 27 includes, wherein the operations further comprise: receiving, from the first processing unit, a third access request to access a third instruction from a third address of the memory; receiving, from the second processing unit, a fourth access request to access the second instruction from the second address of the memory; determining the second instruction was previously stored in a common cache in response to the second access request; determining the priority level associated with the first processing unit is higher than the priority level associated with the second processing unit; retrieving the third instruction from the third address of the memory before providing the second instruction from the common cache; and providing the second instruction from the common cache to the second processing unit instead of retrieving the second instruction from the memory.
In Example 29, the subject matter of Examples 23-28 includes, wherein the operations further comprise: determining the first address and the second address are overlapping addresses in the memory; and retrieving the first instruction only once for both the first and second access requests.
In Example 30, the subject matter of Examples 23-29 includes, wherein the operations further comprise: receiving, from the first processing unit, a third access request to access a third instruction from a third address of the memory; determining that the third instruction requests access to a protected region of the memory; and in response, denying access to the protected region of the memory until a protection condition elapses by returning an alternative instruction.
In Example 31, the subject matter of Example 30 includes, wherein the protection condition comprises completion of a code overlay operation that updates instructions stored in the protected region.
In Example 32, the subject matter of Examples 23-31 includes, wherein the operations further comprise: designating a block of addresses in the memory as an atomic block; and requiring all instructions in the atomic block to be retrieved before providing any instructions from the atomic block to either the first or second processing unit.
In Example 33, the subject matter of Examples 23-32 includes, wherein the alternative instruction is a jump instruction.
Example 34 is at least one machine-readable medium including instructions that, when executed by processing circuitry, cause the processing circuitry to perform operations to implement of any of Examples 1-33.
Example 35 is an apparatus comprising means to implement of any of Examples 1-33.
Example 36 is a system to implement of any of Examples 1-33.
Example 37 is a method to implement of any of Examples 1-33.

What is claimed is:

1. A method, comprising:
at a memory system, using a hardware processor:
receiving, from a first processing unit, a first access request to access a first instruction from a first address of a memory;
receiving, from a second processing unit, a second access request to access a second instruction from a second address of the memory;
determining a priority level associated with the first processing unit is higher than a priority level associated with the second processing unit;
responsive to determining the priority level associated with the first processing unit is higher, retrieving the first instruction from the first address of the memory before retrieving the second instruction from the second address of the memory;
providing the first instruction to the first processing unit within a timing requirement associated with the first processing unit; and
providing, to the second processing unit, an alternative instruction instead of the second instruction responsive to determining the second instruction cannot be provided within a timing requirement associated with the second processing unit, wherein the alternative instruction, when executed by the second processing unit, causes the second processing unit to subsequently request the second instruction from the second address of the memory.

2. The method of claim 1, wherein determining the priority level associated with the first processing unit is higher than the priority level associated with the second processing unit comprises determining that a fixed priority level assigned to the first processing unit is higher than a fixed priority level assigned to the second processing unit.

3. The method of claim 1, wherein determining the priority level associated with the first processing unit is higher than the priority level associated with the second processing unit comprises determining that a type of instruction being accessed by the first processing unit is assigned a higher priority level than a type of instruction being accessed by the second processing unit.

4. The method of claim 1, further comprising:
updating a fixed priority value assigned to the first and second processing units periodically, wherein during a first time period the priority level assigned to the first processing unit is greater than the priority level assigned to the second processing unit and wherein during a second time period, the priority level assigned to the first processing unit is less than the priority level assigned to the second processing unit; and
wherein determining the priority level associated with the first processing unit is higher than the priority level associated with the second processing unit comprises determining that the priority level assigned to the first processing unit during the time period when the first and second access requests were received is higher than the priority level assigned to the second processing unit.

5. The method of claim 1, further comprising:
storing the first instruction in a common cache accessible by both the first and second processing units.

6. The method of claim 5, further comprising:
receiving, from the first processing unit, a third access request to access a third instruction from a third address of the memory;
receiving, from the second processing unit, a fourth access request to access the second instruction from the second address of the memory;
determining the second instruction was previously stored in a common cache in response to the second access request;
determining the priority level associated with the first processing unit is higher than the priority level associated with the second processing unit;
retrieving the third instruction from the third address of the memory before providing the second instruction from the common cache; and
providing the second instruction from the common cache to the second processing unit instead of retrieving the second instruction from the memory.

7. The method of claim 1, further comprising:
determining the first address and the second address are overlapping addresses in the memory; and
retrieving the first instruction only once for both the first and second access requests.

8. The method of claim 1, further comprising:
receiving, from the first processing unit, a third access request to access a third instruction from a third address of the memory;
determining that the third instruction requests access to a protected region of the memory; and in response, denying access to the protected region of the memory until a protection condition elapses by returning an alternative instruction by returning an alternative instruction.

9. The method of claim 8, wherein the protection condition comprises completion of a code overlay operation that updates instructions stored in the protected region.

10. The method of claim 1, further comprising:
designating a block of addresses in the memory as an atomic block; and
requiring all instructions in the atomic block to be retrieved before providing any instructions from the atomic block to either the first or second processing unit.

11. The method of claim 1, wherein the alternative instruction is a jump instruction.

12. A non-transitory machine-readable medium, storing instructions for managing access to shared instruction memory, the instructions, which when executed, cause the machine to perform operations comprising:
receiving, from a first processing unit, a first access request to access a first instruction from a first address of a memory;
receiving, from a second processing unit, a second access request to access a second instruction from a second address of the memory;
determining a priority level associated with the first processing unit is higher than a priority level associated with the second processing unit;
responsive to determining the priority level associated with the first processing unit is higher, retrieving the first instruction from the first address of the memory before retrieving the second instruction from the second address of the memory;
providing the first instruction to the first processing unit within a timing requirement associated with the first processing unit; and
providing, to the second processing unit, an alternative instruction instead of the second instruction responsive to determining the second instruction cannot be provided within a timing requirement associated with the second processing unit, wherein the alternative instruction, when executed by the second processing unit, causes the second processing unit to subsequently request the second instruction from the second address of the memory.

13. The non-transitory machine-readable medium of claim 12, wherein the operation of determining the priority level associated with the first processing unit is higher than the priority level associated with the second processing unit comprises determining that a fixed priority level assigned to the first processing unit is higher than a fixed priority level assigned to the second processing unit.

14. The non-transitory machine-readable medium of claim 12, wherein the operation of determining the priority level associated with the first processing unit is higher than the priority level associated with the second processing unit comprises determining that a type of instruction being accessed by the first processing unit is assigned a higher priority level than a type of instruction being accessed by the second processing unit.

15. The non-transitory machine-readable medium of claim 12, wherein the operations further comprise:
updating a fixed priority value assigned to the first and second processing units periodically, wherein during a first time period the priority level assigned to the first processing unit is greater than the priority level assigned to the second processing unit and wherein during a second time period, the priority level assigned to the first processing unit is less than the priority level assigned to the second processing unit; and
wherein the operation of determining the priority level associated with the first processing unit is higher than the priority level associated with the second processing unit comprises determining that the priority level assigned to the first processing unit during the time period when the first and second access requests were received is higher than the priority level assigned to the second processing unit.

16. The non-transitory machine-readable medium of claim 12, wherein the operations further comprise:
storing the first instruction in a common cache accessible by both the first and second processing units.

17. The non-transitory machine-readable medium of claim 16, wherein the operations further comprise:
receiving, from the first processing unit, a third access request to access a third instruction from a third address of the memory;
receiving, from the second processing unit, a fourth access request to access the second instruction from the second address of the memory;
determining the second instruction was previously stored in a common cache in response to the second access request;
determining the priority level associated with the first processing unit is higher than the priority level associated with the second processing unit;
retrieving the third instruction from the third address of the memory before providing the second instruction from the common cache; and
providing the second instruction from the common cache to the second processing unit instead of retrieving the second instruction from the memory.

18. A computing device for managing access to shared instruction memory, the computing device comprising:
a hardware processor;
a memory, the memory storing instructions, which when executed by the hardware processor cause the computing device to perform operations comprising:
receiving, from a first processing unit, a first access request to access a first instruction from a first address of a memory;
receiving, from a second processing unit, a second access request to access a second instruction from a second address of the memory;
determining a priority level associated with the first processing unit is higher than a priority level associated with the second processing unit;
responsive to determining the priority level associated with the first processing unit is higher, retrieving the first instruction from the first address of the memory before retrieving the second instruction from the second address of the memory;
providing the first instruction to the first processing unit within a timing requirement associated with the first processing unit; and
providing, to the second processing unit, an alternative instruction instead of the second instruction responsive to determining the second instruction cannot be provided within a timing requirement associated with the second processing unit, wherein the alternative instruction, when executed by the second processing unit, causes the second processing unit to subsequently request the second instruction from the second address of the memory.

19. The computing device of claim 18, wherein the operation of determining the priority level associated with the first processing unit is higher than the priority level associated with the second processing unit comprises determining that a fixed priority level assigned to the first processing unit is higher than a fixed priority level assigned to the second processing unit.

20. The computing device of claim 18, wherein the operation of determining the priority level associated with the first processing unit is higher than the priority level associated with the second processing unit comprises determining that a type of instruction being accessed by the first processing unit is assigned a higher priority level than a type of instruction being accessed by the second processing unit.
